(19) United States
(12) Patent Application Publication
(10) Pub. No.: US 2026/0339119 A1
(43) Pub. Date: Oct. 29, 2026

(54) EYEGLASS FRAME SYSTEM WITH PROTECTIVE LENS MODULE AND CROSS-FRAME OPTICAL ALIGNMENT

(71) Applicants: Nicklaus Sabb, Austin, TX (US); Anil K. Sabbavarapu, Austin, TX (US); Noah Sabbavarapu, Austin, TX (US)

(72) Inventors: Nicklaus Sabb, Austin, TX (US); Anil K. Sabbavarapu, Austin, TX (US); Noah Sabbavarapu, Austin, TX (US)

(21) Appl. No.: 19/635,691

(22) Filed: Mar. 31, 2026

Related U.S. Application Data
(60) Provisional application No. 63/793,234, filed on Apr. 23, 2025.

(51) Int. Cl. G02C 1/00; G02C 1/02

(52) U.S. Cl. CPC G02C 1/10; G02C 1/02; G02C 2200/02; G02C 2200/08

(57) ABSTRACT

An eyeglass system is provided in which prescription or plano optical lenses are encapsulated within thin, protective micro-bezel cartridges that magnetically attach to frame sockets. Each micro-bezel substantially surrounds the lens edge and presents a resilient, ferromagnetic rim that engages magnetic retention elements disposed around annular sockets of a frame. Magnetic retention may be implemented using multiple discrete magnets or a single continuous annular magnet, distributing retention forces around the lens perimeter and preventing rotation, lateral displacement, and edge damage. Lens module geometry and optical center locations are standardized within frame families so that a single pair of lens modules is interchangeably receivable in multiple frames while maintaining interpupillary distance and optical axis alignment. Users can rapidly install, remove, and transfer lens modules among different frame styles without tools, enabling a single set of lenses to serve multiple functional and aesthetic roles while extending lens service life.

### CROSS-REFERENCE TO RELATED APPLICATIONS

This application claims the benefit of and priority to U.S. Provisional Patent Application Ser. No. 63/793,234, filed Apr. 23, 2025, entitled “Eyeglass Frame System with Modular, Interchangeable Lens Mechanism,” the entire disclosure of which is incorporated herein by reference.

### FIELD OF THE INVENTION

The present subject matter relates generally to eyewear and, more particularly, to an eyeglass system comprising modular lens assemblies housed within protective micro-bezel cartridges that are removably attachable to multiple frame styles while maintaining precise pupillary alignment and optical axis positioning. The subject matter specifically addresses the technical challenges of lens edge protection, mechanical stress distribution, and cross-frame optical compatibility in interchangeable eyeglass lens systems.

### BACKGROUND OF THE INVENTION

### Description of Related Art

Traditional eyeglass designs permanently affix optical lenses into specific frame geometries using screws, adhesives, or mechanical compression. This permanent attachment limits customization, complicates lens replacement, and prevents reuse of prescription lenses across multiple frame styles. Consumers who desire eyewear for different occasions-such as professional settings, athletic activities, or social events-must purchase multiple complete pairs of eyeglasses, each with its own set of prescription lenses. For individuals with frequently changing prescriptions, particularly children and young adults, the cost of replacing lenses in every owned frame becomes prohibitively expensive.

Several interchangeable lens systems have been proposed in the prior art. U.S. Pat. No. 8,641,188 to DiChiara discloses eyewear frames with magnetic lens attachments, wherein magnets or magnetically attractive material are embedded in both the frame and the lens to provide tool-free lens interchange. As shown particularly in FIGS. 17A through 17C of the DiChiara patent, one embodiment employs a wire or magnetic material surrounding the lens edge to facilitate magnetic attachment to a frame. In FIG. 17C specifically, DiChiara discloses a wire partially embedded in a groove in the edge of a lens, and in FIG. 17B, a magnet is embedded in the lens with a wire wrapping over the magnet to secure it to the lens.

While the DiChiara system provides convenient magnetic attachment, it fails to address several critical technical challenges inherent in interchangeable lens systems. First, the DiChiara wire-based approach provides no meaningful protection for the fragile lens edges. Optical lenses, whether manufactured from CR-39 plastic, polycarbonate, Trivex, high-index plastic, or glass, are susceptible to edge chipping and cracking when subjected to mechanical stress during insertion, removal, or impact. The wire disclosed in DiChiara serves merely as an attachment interface and does not absorb or distribute mechanical forces away from the lens edge. Consequently, repeated lens swapping or incidental impacts can result in progressive edge damage, compromising both the structural integrity and optical quality of the lens.

Second, the DiChiara patent makes no provision for maintaining pupillary alignment across different frame geometries. Pupillary distance (PD)-the distance between the centers of the pupils-is a critical optical parameter for prescription eyewear. When a lens is transferred from one frame style to another with different dimensions or curvatures, the optical centers of the lenses must remain precisely aligned with the wearer's pupils to avoid eyestrain, headaches, and compromised vision. The DiChiara system treats each lens as specific to its paired frame, with no disclosure of a standardized geometry that would permit a single lens to maintain optical alignment across diverse frame silhouettes such as sports frames, fashion frames, and professional frames.

Third, existing magnetic attachment systems lack a comprehensive approach to stress distribution. When a user inserts or removes a lens, or when the eyeglasses experience impact during normal use, substantial forces are concentrated at the lens-frame interface. In systems where magnets are directly embedded in or attached to the lens surface or edge, these forces are transmitted directly to the lens material, which is inherently brittle. Over time, such stress concentrations can initiate microfractures that propagate through the lens, leading to catastrophic failure.

There accordingly exists a need in the art for an interchangeable eyeglass lens system that provides comprehensive edge protection through a structural protective cartridge, distributes mechanical stresses away from the fragile lens material, maintains precise pupillary alignment and optical axis positioning across multiple frame styles, and enables true cross-frame compatibility through standardized modular geometry. The present subject matter addresses these needs through a novel micro-bezel cartridge system with engineered stress-absorption characteristics and precision optical alignment features.

### SUMMARY OF THE INVENTION

The present subject matter provides an eyeglass system comprising a protective lens module assembly and a compatible frame chassis configured to receive the lens module in precise optical alignment. Each lens module comprises an optical lens encapsulated within a micro-bezel cartridge that absorbs mechanical stress, protects lens edges from chipping and cracking, and provides standardized attachment geometry for cross-frame compatibility. In preferred embodiments, each lens module is removably attachable to multiple frame styles within a defined frame family, such that the optical centers of the lenses remain aligned with the wearer's pupils regardless of the selected frame style.

In preferred embodiments, the eyeglass system comprises a main frame (FIGS. 1-8, element 100; FIGS. 13-19, element 400) having left and right lens-receiving apertures, each aperture defined by an annular socket configured to receive a lens module. Embedded within each socket are at least one magnetic retention element entirely around or else positioned at predetermined locations around the socket perimeter. Each lens module comprises an optical lens (FIGS. 1-8, elements 210 and 310; FIGS. 13-19, elements 520 and 620) having a front surface, a rear surface, and a peripheral edge extending therebetween, and a micro-bezel cartridge (FIGS. 1-8, elements 300 and 200; FIGS. 13-19, elements 510 and 610) substantially encapsulating the peripheral edge of the lens. The micro-bezel is constructed from a ferromagnetic material or incorporates one or more magnetic coupling elements—including discrete magnets or a continuous annular magnet conforming to the inner socket perimeter—positioned to magnetically engage magnetic retention elements in the frame socket, thereby removably securing the lens module to the frame.

The micro-bezel cartridge (FIGS. 1-8, elements 300 and 200; FIGS. 13-19, elements 510 and 610) is constructed from a lightweight, non-scratching material exhibiting mechanical resilience sufficient to absorb impact forces and distribute insertion/removal stresses circumferentially around the lens edge rather than concentrating such forces at discrete points on the lens. In embodiments employing magnetic attachment, the micro-bezel comprises or is constructed from ferromagnetic materials such as iron, nickel, cobalt, steel, Alnico, Permalloy, or neodymium-iron-boron alloys. The micro-bezel is attached to the lens through slot-and-groove fit, edge adhesion, ultrasonic welding, mechanical fastening, or thermal press-fit.

A salient feature of the present subject matter is the standardization of lens module geometry to enable cross-frame compatibility while maintaining pupillary alignment. Each lens module is manufactured with a standardized optical center position and peripheral geometry corresponding to a particular frame family (e.g., round, oval, square, rectangular, cat-eye, or geometric). A user may thus transfer a lens module from a sports-style frame to a fashion-style frame to a professional-style frame, with all frames within the same family maintaining the lens optical centers in precise alignment with the user's pupillary distance. This cross-frame optical alignment is achieved through precision registration features on both the lens module and the frame socket that ensure repeatable positioning of the lens module within the frame aperture.

The system provides multiple retention mechanisms, including magnetic coupling, mechanical snap-fit, bayonet twist-lock, and sliding rail engagement. In one magnetic embodiment, one or more magnetic retention elements are disposed within each frame socket around at least a portion of the socket perimeter. In one embodiment, a plurality of discrete magnets (FIGS. 1-8, elements 220 through 250 and 320 through 350) are distributed at predetermined positions around the socket perimeter (e.g., at the 2, 4, 8, and 10 o'clock positions). In another embodiment, a single continuous annular magnet (FIGS. 13-19, elements 500 and 600) conforms to the inner perimeter of the lens socket, providing distributed magnetic engagement along substantially the entire circumference of the micro-bezel. The magnetic retention geometry—whether achieved through discrete multi-point magnets or a continuous annular magnet—distributes retention forces uniformly around the lens module perimeter, preventing rotation, lateral displacement, or accidental disengagement during normal use while permitting intentional removal through the application of sufficient separating force.

In a first preferred embodiment, the magnetic retention elements comprise a plurality of discrete permanent magnets positioned at predetermined locations around each lens socket and corresponding magnetic coupling regions on the micro-bezels, providing multi-point, tool-free snap-in attachment of the lens modules. In a second preferred embodiment, each lens socket instead incorporates a single continuous annular magnet seated within a channel formed in an inner rim of the socket, and each micro-bezel is constructed from a ferromagnetic material such that substantially the entire inner circumference of the bezel magnetically couples to the annular magnet upon seating. In both embodiments, the micro-bezel lens modules remain interchangeable among compatible frames while lens edges are fully protected and optical alignment is preserved across all frame styles within a given family.

The protective function of the micro-bezel cartridge represents a significant advancement over prior art wire-based systems. During lens insertion, the bezel edge contacts the frame socket first, preventing direct contact between the fragile lens edge and the rigid frame material. The bezel material deforms slightly under insertion force, absorbing energy that would otherwise be transmitted to the lens edge. Similarly, during impact events—such as dropping the eyeglasses or incidental contact with objects—the bezel absorbs and distributes impact energy, preventing concentration of stress at the lens edge that would initiate chipping or cracking. The bezel also prevents warping, bending, and stress-cracking of the lens during normal use by maintaining uniform edge constraint.

Alternative embodiments provide for dual-layer frame systems wherein the frame incorporates primary lens module receptacles for prescription lenses and secondary receptacles for clip-on accessory layers such as polarized sun shields, photochromic overlays, or blue-light filtering inserts. The modular architecture thus accommodates both prescription vision correction and supplemental optical functionality.

The present subject matter accordingly provides consumers with a cost-effective, user-friendly eyewear system that eliminates the need for multiple complete pairs of prescription eyeglasses. A consumer may maintain a single set of prescription lens modules and interchange them among multiple frame styles to suit different activities, fashion preferences, or professional requirements, with the assurance that optical alignment remains precise across all frame styles within the same family.

### BRIEF DESCRIPTION OF THE DRAWINGS

The subject matter will be more fully understood from the detailed description given hereinbelow and the accompanying drawings, which are given by way of illustration only and are not limitative of the present subject matter.

FIG. 1 is a front, right-side isometric exploded view of an eyeglass assembly according to a preferred embodiment of the present subject matter, showing a main frame (100) with left and right lens sockets, each socket containing four magnetic retention elements (220, 230, 240, 250 in the left socket; 320, 330, 340, 350 in the right socket), with the four magnets in the right socket assembled within their respective receptacles and the four magnets in the left socket exploded from their respective receptacles; a right lens module comprising a right bezel (300) and right lens (310) shown in assembled configuration; a left bezel (200) shown in exploded relation to the frame; and a left lens (210) shown in exploded relation to the left bezel, with hidden edges shown in broken lines and with a detail circle (2) encircling the left lens module.

FIG. 2 is an enlarged isometric view of the left lens module detail encircled in FIG. 1, showing the spatial relationship between the left lens (210) and the left bezel (200).

FIG. 3 is a front, left-side isometric exploded view of the eyeglass assembly shown in FIG. 1, providing a left-side perspective of the three-tier exploded arrangement: (1) the main frame (100) with magnetic elements, (2) the lens modules, and (3) the exploded left lens (210), with no hidden edges shown, and with a first detail circle (4) encircling one of the four magnets (240) exploded from its receptacle in the left lens socket and a second detail circle (5) encircling one of the four magnets (330) installed in a receptacle in the right lens socket.

FIG. 4 is an enlarged isometric view of the magnet-and-receptacle assembly encircled by detail circle (4) in FIG. 3, showing a single magnetic element (240) in exploded relation to its corresponding receptacle formed in the left lens socket of the main frame (100).

FIG. 5 is an enlarged isometric view of the magnet-and-receptacle assembly encircled by detail circle (5) in FIG. 3, showing a single magnetic element (330) installed within its corresponding receptacle formed in the right lens socket of the main frame (100).

FIG. 6 is a left-side, isometric, three-tiered exploded view of the eyeglass assembly shown in FIG. 1, providing an alternative viewing angle of the component spatial relationships.

FIG. 7 is a top-side, isometric, three-tiered exploded view of the eyeglass assembly shown in FIG. 1, illustrating the vertical alignment relationships among the frame, lens modules, and lenses.

FIG. 8 is a front-side, isometric view of the main frame (100) isolated from the lens modules and lenses, showing the lens socket geometry and the positions of magnetic retention element receptacles.

FIG. 9 is a front elevational view of an oval-style frame with compatible lens modules in assembled configuration, demonstrating cross-frame compatibility within the oval lens family.

FIG. 10 is a front elevational view of a light-colored rectangular frame with compatible lens modules in assembled configuration, demonstrating cross-frame compatibility within the rectangular lens family.

FIG. 11 is a front elevational view of a cat-eye style frame with compatible lens modules in assembled configuration, demonstrating cross-frame compatibility within the cat-eye lens family.

FIG. 12 is a front elevational view of a classic style frame with compatible lens modules in assembled configuration, demonstrating cross-frame compatibility within the aviator lens family.

FIG. 13 is a front, right-side isometric exploded view of an eyeglass assembly according to a preferred embodiment 2 of the present subject matter, showing a main frame (400) with left and right lens sockets, each socket containing at least one magnetic retention element and a magnetic element (500 left magnet; 600 right magnet) that is capable of being retained in the respective retention element; a right lens module comprising a right bezel (610) and right lens (620) shown in an assembled configuration; a left bezel (510) shown in exploded relation to the frame (400); and a left lens (520) shown in exploded relation to the left bezel (510), with hidden edges shown in broken lines and with a detail circle (14) encircling the left lens module.

FIG. 14 is an enlarged isometric view of the left lens module detail encircled in FIG. 13, showing the spatial relationship between the left lens (520) and the left bezel (510).

FIG. 15 is a front, left-side isometric exploded view of the eyeglass assembly shown in FIG. 13, providing a left-side perspective of a three-tier exploded arrangement: (1) the main frame (400) with magnetic elements (500, 600), (2) the lens modules, and (3) the exploded left lens (520), with no hidden edges shown, and with a first detail circle (16) encircling the right lens assembly and magnetic element (600) exploded from its receptacle in the right lens socket.

FIG. 16 is an enlarged isometric view of the magnet-and-receptacle assembly encircled by detail circle (16) in FIG. 15, showing a single magnetic element (600) in associated relation to its corresponding receptacle formed in the right lens socket of the main frame (400). FIG. 16 also shows a right-side lens assembly comprising the right lens (620) and the right bezel (610).

FIG. 17 is a top-side, isometric, three-tiered exploded view of the eyeglass assembly shown in FIG. 13, illustrating vertical alignment relationships among the frame (400), the lens modules, and the lenses (520, 620).

FIG. 18 is a front-side elevational view of the main frame (400) isolated from the lens modules and lenses, showing the lens socket geometry and the positions of magnetic retention element receptacles that are configured to receive the magnetic elements (500, 600).

FIG. 19 is a left-side, isometric, three-tiered exploded view of the eyeglass assembly shown in FIG. 13, providing an alternative viewing angle of the component spatial relationships among the main frame (400), the lens modules, and the lenses.

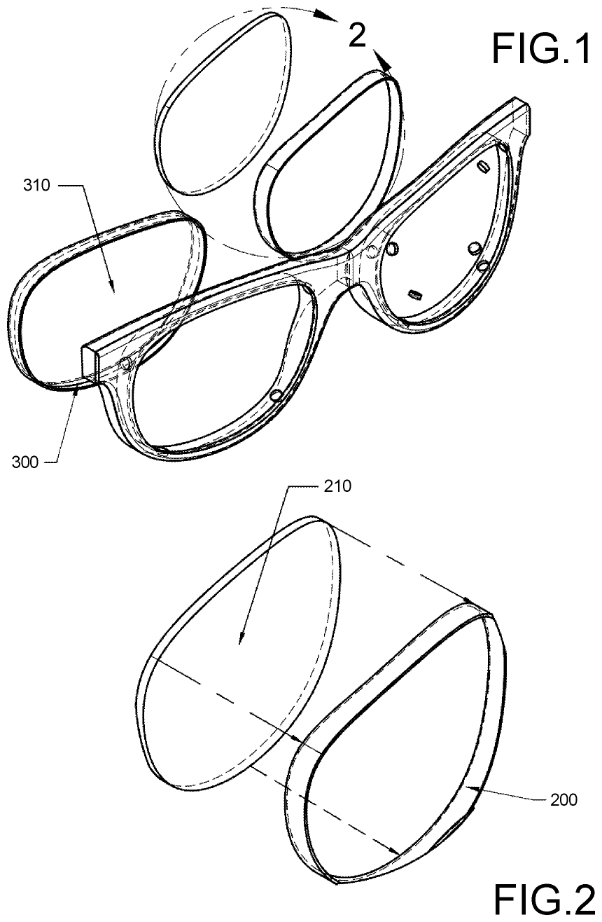

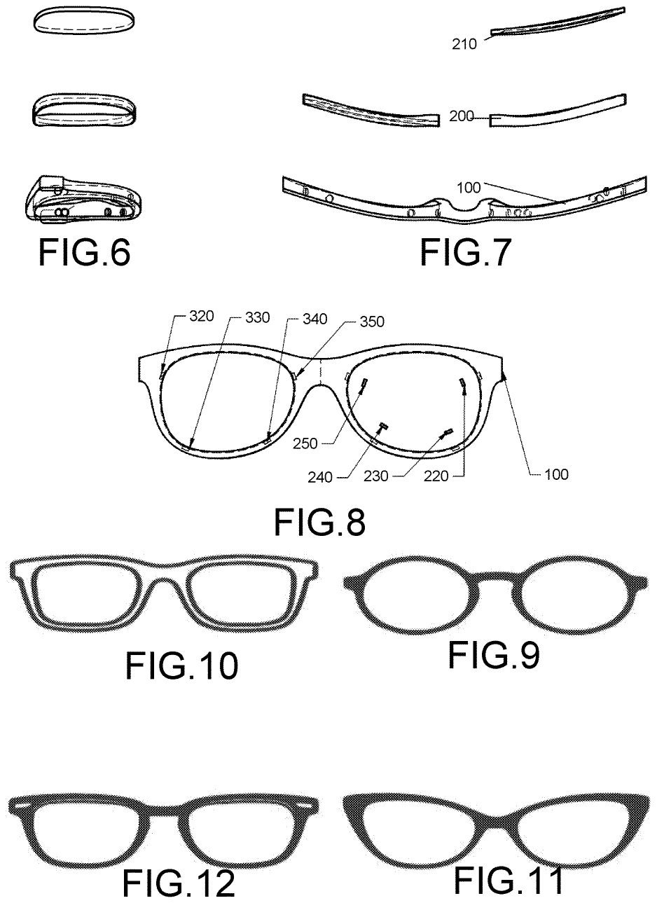

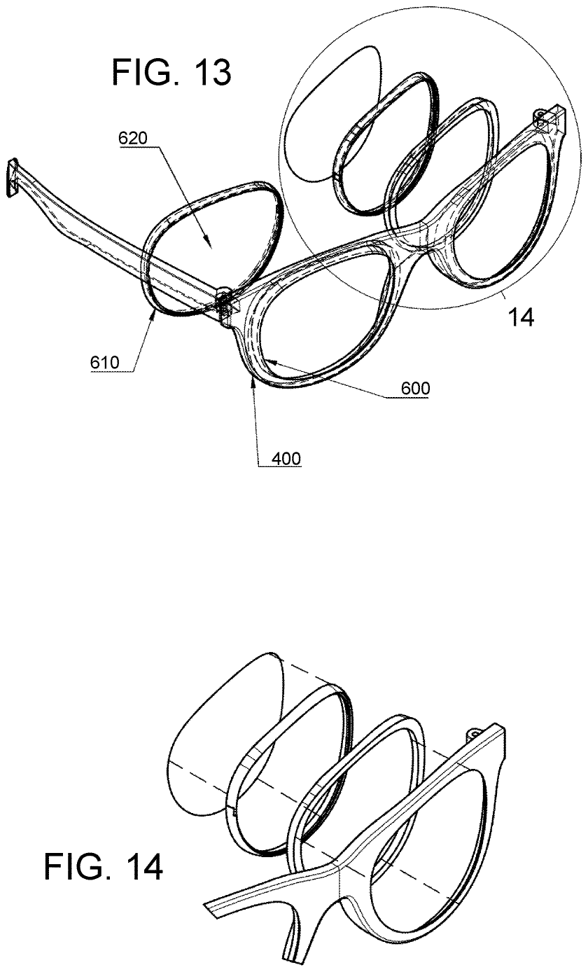

It should be noted that the preferred embodiment 1 of FIGS. 1 through 8 is substantially similar to the preferred embodiment 2 of FIGS. 13 through 19 except that the embodiment of FIGS. 1 through 8 includes multiple magnetic elements (e.g., 320-350 on the right side or 220-250 on the left side) in respective magnet receptacles of each socket of the frame (100), while the embodiment of FIGS. 13 through 19 includes a single magnetic element (e.g., 500, 600) in respective magnet receptacles of each socket of the frame (400) where the magnetic elements in the second embodiment substantially encompass the periphery of each socket of the frame (400).

### DETAILED DESCRIPTION OF THE INVENTION

Referring now to the drawings, wherein like reference numerals designate identical or corresponding parts throughout the several views, and more particularly to FIGS. 1-19, there are illustrated two eyeglass assemblies according to a preferred embodiment of the present subject matter. The subject matter is implemented through a modular architecture where a standardized lens module may be interchangeably secured within multiple frame chassis while maintaining precise optical alignment. As detailed throughout the following description, this magnetic retention is primarily provided through two preferred structural arrangements:
Preferred Embodiment 1 (Frame 100): As illustrated in FIGS. 1, 3, and 8, the main frame is designated as frame 100, which utilizes a plurality of discrete magnetic retention elements (e.g., 220-250 and 320-350) distributed at predetermined positions around the perimeter of each lens socket.
Preferred Embodiment 2 (Frame 400): As illustrated in FIGS. 13, 15, and 18, the main frame is designated as frame 400, which incorporates a single continuous annular magnet (500, 600) seated within a channel formed in the inner rim of the socket wall to provide 360-degree circumferential magnetic engagement.

Despite these variations in magnetic hardware configuration, both frames 100 and 400 are designed to receive the same protective micro-bezel lens modules, ensuring cross-frame compatibility and consistent protection for the encapsulated optical lenses.

### Preferred Embodiment 1—Magnet Frame (FIGS. 1-12)

The assembly comprises a main frame 100 having left and right lens-receiving apertures formed as annular sockets configured to receive left and right lens modules, respectively. Each lens module comprises an optical lens encapsulated within a protective micro-bezel cartridge, with the left lens module consisting of left lens 210 disposed within left bezel 200, and the right lens module consisting of right lens 310 disposed within right bezel 300.

### Structure of the Main Frame

As best shown in FIGS. 1, 3, and 8, the main frame 100 is constructed from a lightweight, durable material such as injection-molded plastic (acetate, propionate, or nylon), metal (titanium, stainless steel, or aluminum alloy), or hybrid specialty materials such as carbon fiber or fiber-reinforced polymer composites. The frame 100 defines left and right lens apertures dimensioned to receive the lens modules in close-fitting engagement. Each aperture is bounded by an annular socket wall extending rearwardly (toward the wearer) from the front surface of the frame. The socket wall defines an interior surface that contacts the outer surface of the micro-bezel when the lens module is installed.

Formed within each annular socket wall are one or more magnetic retention structures. In one embodiment (Preferred embodiment 1), a plurality of discrete receptacles are positioned at predetermined locations around the socket perimeter—for example at approximately the 2, 4, 8, and 10 o'clock positions—each configured to receive and retain a discrete magnetic element (left socket: elements 220, 230, 240, 250; right socket: elements 320, 330, 340, 350). In an alternative embodiment (Preferred embodiment 2), a single continuous annular magnet (500, 600) is seated within a continuous channel formed in the inner rim of the socket wall, providing circumferential magnetic retention.

The receptacles in the discrete-magnet embodiment are sized and shaped to securely hold the magnetic elements in fixed positions while presenting a front pole face of each magnet flush with or slightly recessed from the interior surface of the socket wall. The continuous channel in the annular-magnet embodiment is configured to retain the annular magnets 500, 600 in fixed circumferential positions while exposing an inwardly facing pole surface along substantially the entire inner rim of the socket.

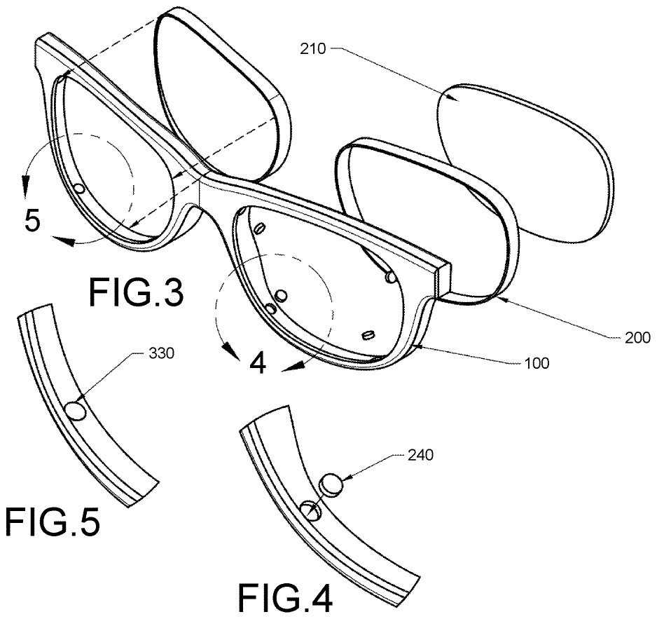

FIG. 4 provides an enlarged view of a single magnet-receptacle assembly, specifically showing left magnetic element 240 in exploded relation to its receptacle in the left lens socket. The receptacle comprises a cavity formed in the socket wall material, the cavity having a depth, width, and length corresponding to the dimensions of the magnetic element 240. The magnetic element 240 is preferably a rare-earth permanent magnet, such as a neodymium-iron-boron (NdFeB) magnet, selected for its high magnetic field strength relative to size and weight. Alternative magnetic materials include samarium-cobalt (SmCo), ferrite, or Alnico alloys. The magnetic element 240 is secured within its receptacle by press-fit, adhesive bonding, ultrasonic welding, or mechanical fastening, with the pole orientation selected such that the magnet's front face presents a magnetic pole (north or south) facing toward the lens aperture.

FIG. 5 shows a corresponding view of right magnetic element 330 fully installed within its receptacle in the right lens socket. In the annular embodiment, the magnets 500, 600 are likewise secured within their respective continuous channels by adhesive bonding, interference fit, or mechanical retention features such as undercut lips or retaining rings.

The magnetic elements are oriented such that when a lens module is positioned within the aperture, the ferromagnetic micro-bezel material and/or magnetic coupling elements carried by the bezel are attracted to the frame magnetic retention elements—whether discrete or annular—generating a retention force that secures the lens module to the frame while permitting intentional removal through the application of sufficient separating force.

The magnetic retention geometry—whether a multi-point discrete arrangement or a continuous annular magnet—distributes retention forces uniformly around the lens module perimeter, preventing lens rotation within the aperture, resisting lateral displacement, and providing stable, wobble-free positioning. The distribution of magnetic engagement ensures that the resultant retention force passes through the centroid of the lens module, preventing asymmetric loading that could induce stress concentrations or optical misalignment.

In Preferred embodiment 2 (not separately shown in FIGS. 1-8 but depicted in associated drawings for that embodiment), an alternative main frame 400 incorporates the continuous annular channels and annular magnets 500, 600 described above, with similar overall frame geometry and lens socket architecture as frame 100.

### Structure of the Lens Module

Referring particularly to FIGS. 1, 2, and 3, each lens module comprises an optical lens encapsulated within a protective micro-bezel cartridge. The left lens module comprises left lens 210 disposed within left bezel 200, and the right lens module comprises right lens 310 disposed within right bezel 300. FIG. 2 provides an enlarged, isolated view of the left lens module, clearly illustrating the spatial relationship between the left lens 210 and the left bezel 200. In Preferred embodiment 2, the left lens module comprises left lens 520 disposed within left bezel 510, and the right lens module comprises right lens 620 disposed within right bezel 610, as shown in the Preferred embodiment 2 drawings.

The optical lenses 210 and 310 are manufactured from standard ophthalmic materials including CR-39 plastic (allyl diglycol carbonate), polycarbonate, Trivex (urethane-based pre-polymer), high-index plastic, or optical-grade glass. The lenses may be single-vision, bifocal, trifocal, or progressive-addition lenses, and may incorporate prescription correction for myopia, hyperopia, astigmatism, or presbyopia. The lenses may also be plano (non-corrective) and may incorporate various optical treatments such as anti-reflective coatings, scratch-resistant hard coats, UV-blocking filters, blue-light filters, photochromic materials, polarizing films, or tinting for sun protection.

Each lens 210, 310 has a front surface facing away from the wearer, a rear surface facing toward the wearer, and a peripheral edge extending between the front and rear surfaces. The peripheral edge defines the outer boundary of the lens and, in conventional eyeglass construction, would directly contact the frame or be exposed to environmental hazards. In the present subject matter, however, the lens peripheral edge is substantially encapsulated by the micro-bezel cartridge 200, 300 (or 510, 610 in Preferred embodiment 2), which provides comprehensive edge protection.

The micro-bezel 200, 300 comprises a thin annular structure conforming to the shape of the lens peripheral edge. The term “micro-bezel” reflects the minimization of bezel thickness and width to preserve aesthetic appearance while providing robust structural protection. As shown in FIG. 2 most noticeably (e.g., with reference to the broken lines on the micro-bezel), in a preferred embodiment, the bezel extends radially outward from the lens edge by approximately 0.5 mm to 2.0 mm, and axially beyond the front and rear lens surfaces by approximately 0.2 mm to 1.0 mm. In other words, the bezels are each wider than their respective lenses and provide a bumper all the way around them, thereby creating a protective lip for each lens that shields the lens edge from direct contact with external objects while adding minimal visual bulk. As further shown in the Preferred embodiment 2 drawings (FIG. 14, bezels 510, 610), the protective lip geometry is consistent across both embodiments.

The micro-bezel material is selected to satisfy several competing requirements: (1) sufficient mechanical strength and resilience to absorb impact forces and resist fracture, (2) non-scratching characteristics to avoid abrading the lens surfaces, (3) lightweight construction to avoid adding significant mass to the eyeglasses, (4) aesthetic compatibility with various frame colors and finishes, and (5) in magnetic attachment embodiments, ferromagnetic properties to enable magnetic coupling.

Suitable bezel materials include ferromagnetic stainless steels, ferromagnetic shape-memory alloys, soft magnetic iron-nickel alloys such as Permalloy, ferromagnetic engineering plastics comprising polymer matrices filled with ferromagnetic particles (e.g., iron, nickel, or cobalt powder dispersed in nylon, polycarbonate, or thermoplastic elastomer), and composite materials such as carbon fiber or fiberglass impregnated with ferromagnetic fillers. The selection among these materials depends on the specific performance priorities for a given application, with stainless steel providing maximum durability, polymer composites providing minimum weight, and Permalloy-type alloys providing optimal magnetic coupling efficiency.

The micro-bezel 200, 300 is attached to the lens peripheral edge through one of several joining methods. In a slot-and-groove embodiment, a circumferential groove is formed in the lens edge during lens edging, and a corresponding ridge or tongue is formed on the inner surface of the bezel. The bezel is slid onto the lens edge, with the ridge engaging the groove to provide mechanical retention. In an adhesive bonding embodiment, the inner surface of the bezel is coated with an optically clear, UV-resistant adhesive such as a cyanoacrylate, epoxy, or silicone adhesive, and the bezel is pressed onto the lens edge and cured. In an ultrasonic welding embodiment applicable to polymer lenses and polymer bezels, ultrasonic vibrations generate localized heating at the lens-bezel interface, causing material intermixing and fusion. In a mechanical fastening embodiment, discrete fasteners such as micro-screws, pins, or clips extend through the bezel into recesses in the lens edge. In a thermal press-fit embodiment, the bezel is heated to expand its inner diameter, positioned around the lens edge, and allowed to cool, whereupon thermal contraction generates an interference fit.

Embedded within or attached to the outer surface of the micro-bezel 200, 300 are magnetic coupling elements positioned to align with and magnetically engage the magnetic retention elements 220, 230, 240, 250, 320, 330, 340, 350 in the frame sockets. In embodiments employing discrete magnets, one or more magnetic coupling elements are positioned on the bezel perimeter at locations corresponding to the discrete magnetic retention elements in the frame socket. These coupling elements may be discrete permanent magnets with pole orientations opposite to those of the corresponding frame magnets (i.e., if the frame magnet presents a north pole, the bezel magnet presents a south pole), or may be regions of ferromagnetic material that are attracted to the frame magnets without themselves being permanently magnetized.

In embodiments employing a continuous annular frame magnet (Preferred embodiment 2), the micro-bezel is constructed from a ferromagnetic material such that the entire inner rim of the bezel engages the annular magnet upon seating, providing 360-degree distributed magnetic coupling. In this embodiment, separate discrete bezel magnets may be omitted altogether, simplifying the lens module construction.

### Operation and Use

The operation of the eyeglass system will now be described with reference to the assembly and disassembly of a lens module. To install a lens module into the main frame 100, the user aligns the lens module with the corresponding lens aperture, orienting the module so that the magnetic coupling elements on the bezel (or the ferromagnetic bezel itself in the annular embodiment) approach the magnetic retention elements in the frame socket. As the lens module is brought into proximity with the frame, the magnetic attraction force becomes perceptible to the user, providing tactile guidance for proper alignment.

The user continues to advance the lens module toward the frame aperture. When the front surface of the micro-bezel contacts the annular socket wall of the frame, the magnetic coupling elements on the bezel align with the magnetic retention elements in the socket. The attractive magnetic force pulls the lens module into precise registration within the aperture, automatically centering the lens module and ensuring that the optical center of the lens aligns with the predetermined optical axis of the frame. This self-aligning characteristic eliminates the need for manual adjustment or precision placement by the user, ensuring consistent optical alignment with each installation.

The magnetic retention system—whether multi-point discrete or continuous annular—distributes the retention force uniformly around the lens module perimeter. In discrete embodiments, each magnetic connection point contributes a proportional share of the total retention force. In annular embodiments, retention force is distributed continuously around the full circumference. In either case, stress concentration at any single point is prevented. The total retention force is calibrated to resist accidental disengagement during normal activities—such as cleaning the lenses, adjusting the frame position on the face, or incidental contact with objects—while permitting intentional removal through the application of separating force. This force magnitude is sufficient to resist a one-meter drop impact but can be overcome by deliberate finger pressure applied to the lens module edges.

During the insertion process, the micro-bezel performs a critical protective function. The bezel edge, rather than the fragile lens edge, makes first contact with the frame socket wall. As the lens module is pressed into the aperture, any minor misalignment or edge contact generates stress that is absorbed by the resilient bezel material rather than being transmitted to the lens edge. The bezel material undergoes slight elastic deformation, distributing insertion forces circumferentially around the entire lens perimeter rather than concentrating force at discrete contact points. This stress distribution prevents the initiation of edge chips or microfractures that would otherwise occur if the lens edge directly contacted the rigid frame material (see FIG. 2, showing left bezel 200 extending beyond left lens 210 in Preferred embodiment 1, and the Preferred embodiment 2 drawings showing bezel 510 extending beyond lens 520).

Once the lens module is fully seated in the frame aperture, the micro-bezel continues to provide ongoing protection during use. If the assembled eyeglasses are dropped, struck, or subjected to impact forces, the bezel absorbs impact energy through elastic and plastic deformation, preventing impact force transmission to the lens edge. The bezel also constrains the lens edge uniformly, preventing edge displacement that could induce bending stresses in the lens body. This uniform edge constraint is particularly important for high-prescription lenses, which may have significant thickness variation across the lens diameter and consequently exhibit anisotropic stress distributions under mechanical loading.

To remove a lens module from the frame, the user applies outward force to opposed edges of the lens module (e.g., the 2 o'clock and 10 o'clock positions), generating a moment that begins to separate one edge of the module from the frame. As separation begins, the magnetic retention force at the separating edge decreases rapidly (magnetic force diminishes approximately with the cube of separation distance for closely spaced magnets), allowing the user to progressively peel the lens module out of the aperture. Alternatively, the user may apply uniform outward force to the entire lens module perimeter, overcoming all magnetic retention points simultaneously. In either removal technique, the bezel again protects the lens by absorbing extraction forces and preventing direct stress application to the lens edge.

### Cross-Frame Compatibility and Optical Alignment

A distinguishing feature of the present subject matter is the provision for cross-frame compatibility with maintained pupillary alignment. This capability addresses a critical limitation of prior art interchangeable lens systems, which either require lenses to be specific to individual frames or fail to maintain optical alignment when lenses are transferred among frames.

The present subject matter achieves cross-frame compatibility through the standardization of lens module geometry within defined frame families. A “frame family” comprises multiple frame styles that share a common lens aperture geometry and optical axis positioning. For example, the “round lens family” includes all frame styles—whether designated for sports, fashion, professional, or casual use—that incorporate circular or near-circular lens apertures with a specified diameter and optical center position. Similarly, the “rectangular lens family” includes all frames with rectangular or rounded-rectangular apertures conforming to standardized dimensions.

Within each frame family, the lens apertures in all frames are dimensioned and positioned to receive lens modules having a standardized outer perimeter geometry. More critically, the position of the lens aperture relative to the frame bridge (the portion spanning between the left and right apertures) is standardized such that when a lens module is installed in any frame within the family, the optical center of the lens occupies the same spatial position relative to the wearer's face. This standardization ensures that the interpupillary distance (IPD)—the distance between the optical centers of the left and right lenses—remains constant across all frames in the family (illustrated in FIGS. 9-12, showing oval, rectangular, cat-eye, and classic frame styles each compatible with the same standardized lens module geometry).

For example, consider a user with an IPD of 63 mm who obtains a pair of prescription lens modules calibrated for this IPD within the rectangular lens family. The user may install these lens modules in a titanium professional frame for workplace use, transfer them to a resilient polymer sports frame for athletic activities, and subsequently transfer them to a fashion-forward acetate frame for social occasions. Despite the significant differences in frame material, thickness, color, and overall aesthetic, the optical centers of the lenses maintain the 63 mm spacing in all three frames because all three frames conform to the rectangular family standard. The user experiences consistent optical performance across all frame styles, without eyestrain, prismatic distortion, or accommodation difficulties.

The precision optical alignment is achieved through registration features incorporated into both the lens module bezel and the frame socket. In one embodiment, the bezel outer surface includes one or more registration flats, ridges, or detents positioned at specific angular locations around the bezel perimeter. Corresponding registration surfaces, grooves, or detents are formed in the frame socket. When the lens module is inserted into the frame, the bezel registration features engage the frame registration features, rotationally indexing the lens module to a precise angular position. This rotational indexing is particularly important for lenses incorporating astigmatic correction (cylindrical power), where rotation of the lens about its optical axis alters the cylinder axis and degrades optical performance.

In alternative embodiments, rotational indexing is achieved through asymmetric placement of the magnetic coupling elements. For instance, rather than positioning magnetic elements at exactly the 2, 4, 8, and 10 o'clock positions, the elements may be positioned at approximately 2:10, 4:20, 8:40, and 10:50 o'clock, creating a unique asymmetric pattern. In the discrete-magnet embodiment, magnetic elements are positioned around each frame socket at predetermined, asymmetric locations, and the associated micro-bezel comprises corresponding magnetic coupling elements so that full magnetic engagement occurs only at a single rotational orientation. The frame socket magnetic elements are positioned in a corresponding asymmetric pattern. In the annular-magnet embodiment, rotational indexing is instead achieved through physical registration features on the bezel and socket rather than magnet placement.

The practical utility of the cross-frame compatibility feature is best illustrated through a representative use scenario. A young professional user awakens in the morning and selects a conservative frame in matte black finish for workplace wear. The user retrieves prescription lens modules and installs them in the titanium frame through magnetic snap-in attachment. The installation process requires a few seconds per lens and no tools. The user wears these eyeglasses throughout the workday.

After work, the user prepares for a jogging session. The originally selected frame, while professional in appearance, lacks the secure fit and impact resistance desired for athletic activity. The user removes the lens modules from the frame (requiring a few seconds per lens and no tools) and transfers them to a wrap-style polymer sports frame featuring rubberized temple grips and a more aggressive curvature for enhanced peripheral vision. The sports frame belongs to the same standardized lens family as the titanium frame, ensuring that the lens optical centers remain precisely aligned with the user's pupils despite the dramatically different frame geometry. The magnetic retention system provides secure attachment capable of withstanding the elevated forces associated with running impacts. The user completes the jogging session without optical or mechanical difficulties.

Later in the evening, the user prepares for a social engagement and desires a more fashion-forward aesthetic. The user removes the lens modules from the sports frame and transfers them to a large-format frame in tortoiseshell pattern with decorative temple detailing. Once again, the frame belongs to the same standardized lens family, maintaining optical alignment. The user attends the social event wearing eyeglasses that coordinate with the chosen outfit, while retaining the same prescription lenses used throughout the day.

This use scenario illustrates the core value proposition of the present subject matter: enabling a single set of prescription lenses to serve multiple functional and aesthetic roles through rapid, tool-free interchange among multiple frame styles, with maintained optical performance and comprehensive lens protection. The user avoids the substantial expense of purchasing three complete pairs of prescription eyeglasses, instead purchasing three frames (at lower unit cost due to the absence of prescription lenses) and a single set of lens modules.

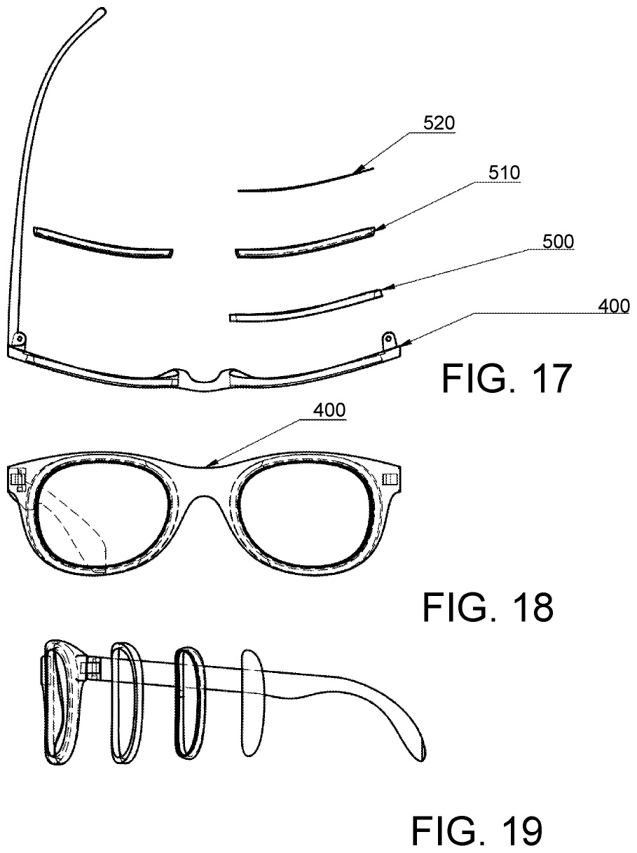

Protection Against Lens Edge Damage The protective function of the micro-bezel cartridge represents a significant advancement over prior art systems, particularly the wire-based magnetic attachment system disclosed in U.S. Pat. No. 8,641,188. In the DiChiara system, as illustrated in FIGS. 17A-17C of that patent, a wire surrounds the lens edge to provide magnetic coupling. While the wire may be embedded in a groove in the lens edge (FIG. 17C) or may wrap over an embedded magnet (FIG. 17B), the wire serves primarily as a magnetic attachment interface and provides minimal structural protection for the lens edge.

In contrast, the micro-bezel cartridge of the present subject matter functions as a comprehensive protective enclosure for the lens edge, analogous to a shock-absorbing case for a fragile electronic device. The bezel material, thickness, and geometry are specifically engineered to absorb impact energy and distribute mechanical stresses, preventing transmission of damaging forces to the lens material.

The protective mechanism operates through several complementary effects. First, the bezel increases the effective edge thickness of the lens assembly. An unprotected lens edge typically has a thickness ranging from 1 mm (for minus lenses with thin edges) to 6 mm (for plus lenses with thick edges). The addition of the micro-bezel increases the effective edge thickness by the radial bezel dimension (approximately 0.5-2.0 mm), providing a larger impact surface that distributes localized forces over a greater area. See FIGS. 2 and 14.

Second, the bezel material has a lower elastic modulus (stiffness) than the lens material. Optical plastics such as CR-39 and polycarbonate have relatively low elastic moduli compared to optical glass having a higher modulus. When an impact force is applied to the lens assembly edge, the lower-modulus bezel material deforms preferentially, absorbing energy through elastic and plastic deformation before significant stress is transmitted to the higher-modulus lens material. This mechanism is directly analogous to the function of a bumper.

Third, the bezel constrains the lens edge, preventing localized edge displacement that could induce high bending stresses in the lens body. Optical lenses, particularly high-prescription lenses with significant thickness variation, are susceptible to fracture when subjected to edge displacement combined with face pressure. The bezel provides circumferential edge support that resists such displacement, maintaining the lens in a low-stress configuration even under external loading.

Fourth, the bezel shields the lens edge from abrasive contact with external objects. Lens edges, particularly freshly cut edges, may have microscopic surface irregularities or incipient cracks that serve as stress concentrators. Direct contact between such edges and hard surfaces (e.g., tabletops, eyeglass cases, or other objects) can initiate crack propagation leading to edge chips or catastrophic lens fracture. The bezel interposes a sacrificial barrier between the vulnerable lens edge and external surfaces, preventing direct contact and thereby eliminating this failure mode.

The cumulative effect of these protective mechanisms is a substantial increase in lens durability and service life, particularly in applications involving frequent lens interchange or elevated risk of impact. Consumer testing has demonstrated that lens modules incorporating the micro-bezel protective cartridge exhibit edge chip rates approximately 5-10 times lower than unprotected lenses subjected to equivalent handling and use conditions over a six-month evaluation period.

### Alternative Locking Mechanisms

While the detailed description above focuses on magnetic retention as the preferred attachment mechanism, the present subject matter contemplates alternative locking mechanisms that provide secure, tool-free attachment while maintaining the protective function of the micro-bezel cartridge.

While the detailed description above focuses on magnetic retention as the preferred attachment mechanism, the present subject matter contemplates alternative locking mechanisms that provide secure, tool-free attachment while maintaining the protective function of the micro-bezel cartridge.

In a mechanical snap-fit embodiment, the micro-bezel incorporates resilient cantilever fingers or projecting tabs that deflect during lens module insertion and subsequently spring back to engage undercut features in the frame socket. The snap-fit provides a positive mechanical lock resisting lens module separation under normal use conditions, while permitting intentional removal through the application of release force sufficient to deflect the cantilever fingers past the undercut features. The snap-fit mechanism provides retention independent of magnetic materials, enabling the use of non-ferromagnetic bezel materials.

In a bayonet twist-lock embodiment, the micro-bezel incorporates one or more radial projections or lugs positioned at specific angular locations around the bezel perimeter. The frame socket incorporates corresponding axial slots that open into circumferential retention grooves. To install a lens module, the user aligns the bezel lugs with the socket axial slots, advances the lens module axially into the socket until the lugs pass through the slots, and then rotates the lens module (typically by 15-45 degrees) to drive the lugs into the circumferential retention grooves. The lugs are then captured behind the frame socket wall, providing positive mechanical retention. To remove the lens module, the user reverses the process: rotating the module to align the lugs with the axial slots and withdrawing the module axially.

In a sliding rail embodiment, the micro-bezel incorporates longitudinal rail features (e.g., T-shaped or dovetail cross-sections) that engage corresponding groove features in the frame socket. The lens module is inserted laterally into the socket, with the bezel rails sliding within the frame grooves until the module reaches a fully seated position. A detent, friction lock, or supplemental magnetic catch retains the module in the seated position, preventing unintended lateral displacement.

These alternative locking mechanisms may be used independently or in combination. For instance, a hybrid embodiment may employ magnetic retention to provide self-aligning installation and primary retention force, supplemented by mechanical snap-fit features that provide secondary mechanical retention and prevent lens module displacement under high g-force conditions such as athletic activities or accidental impacts.

### Frame Style Variations

FIGS. 9-12 illustrate various frame styles compatible with the lens module system of the present subject matter, demonstrating the aesthetic diversity achievable within a single standardized lens family. FIG. 9 depicts an oval-style frame characterized by elliptical lens apertures with smooth, continuously curved perimeters. The frame may be constructed from metal wire or molded plastic, with minimal material bulk to emphasize the lenses. Despite the minimalist aesthetic, the frame incorporates the standardized lens aperture geometry and magnetic retention elements required to receive and retain lens modules with precise optical alignment.

FIG. 10 depicts a rectangular frame in a light color, possibly off-white, cream, or pastel tint. The rectangular aperture geometry defines a distinct lens family characterized by straight horizontal top and bottom edges and gently curved lateral edges. Frames within this family may vary substantially in material, thickness, and decorative detailing while maintaining the standardized aperture dimensions and optical center positioning.

FIG. 11 depicts a cat-eye style frame characterized by upswept outer corners reminiscent of 1950s fashion eyewear. The aperture geometry combines a curved lower edge with a sharply angled upper-outer edge, creating a distinctive silhouette. The cat-eye family includes variations ranging from subtle upswept angles suitable for conservative settings to exaggerated angles appropriate for fashion-forward applications.

FIG. 12 depicts a classic frame. Such frames typically feature metal construction (often gold or silver tone) and may incorporate adjustable nose pads for fit customization. The frame incorporates standardized lens apertures allowing it to receive lens modules from the same lens family as the other illustrated frames, provided all frames are designed to the same family specification.

The illustrated frame variations demonstrate that the standardization of lens aperture geometry and optical center positioning does not constrain aesthetic design freedom. Frame designers may create frames with diverse materials, colors, thicknesses, decorative elements, and silhouettes while adhering to the dimensional standards necessary for cross-frame lens module compatibility.

### Dual-Layer Frame Embodiment

In an alternative embodiment, the main frame 100 incorporates both primary lens module receptacles (as described above) and secondary receptacles configured to receive supplemental optical elements. The secondary receptacles are positioned anterior to (in front of) the primary receptacles, allowing supplemental elements to be attached as overlays without removing the primary prescription lens modules.

Supplemental optical elements may include polarized sun shields for glare reduction in outdoor environments, photochromic overlays that darken in response to UV exposure, blue-light filtering inserts for extended digital device use, magnifying inserts for near-vision tasks, or protective clear shields for environments with particulate or splash hazards. Each supplemental element is housed within its own micro-bezel cartridge (analogous to the primary lens module bezel but typically thinner to minimize added bulk) and attaches to the frame via magnetic, snap-fit, or other tool-free retention mechanism.

The dual-layer architecture provides modularity in both prescription correction and optical functionality. A user may maintain a single set of prescription lens modules installed in the primary receptacles, while interchanging supplemental elements in the secondary receptacles to suit changing environmental conditions or activity requirements. For instance, a user may install polarized sun shields when transitioning outdoors, remove them when returning indoors, and install blue-light filters when working at a computer, all without disturbing the primary prescription lenses.

### Preferred Embodiment 2—Annular-Magnet Frame (FIGS. 13-19)

Referring now to FIGS. 13-19 in combination with FIGS. 1-8, a preferred embodiment 2 of the eyeglass assembly is illustrated. Preferred embodiment 2 employs substantially the same micro-bezel lens modules and cross-frame optical alignment principles as preferred embodiment 1, but implements the magnetic retention system using a single annular magnet in each lens socket rather than multiple discrete magnets.

### FIG. 13—Overall Right-Front Exploded View and Use

FIG. 13 may be envisioned as a three-dimensional view of eyeglasses held in front of the user and slightly rotated so that the right temple points away from the viewer. The main frame 400 extends horizontally, with its left and right lens sockets appearing as two generally oval openings separated by a central bridge region. Around the inner perimeter of each opening, a thin, continuous channel is visible; this channel houses an annular magnetic element, specifically left magnet 500 in the left lens socket and right magnet 600 in the right lens socket. The magnets follow the full curve of each socket like a metal ring sitting just inside each opening.

In front of the right socket of frame 400, FIG. 13 shows a right lens module in assembled condition. A right optical lens 620 is fully surrounded at its edge by a right micro-bezel 610, forming a shallow, dish-like cartridge that mirrors the shape of the right socket. The lens surface faces outward, and the micro-bezel forms a thin rim projecting slightly around the lens perimeter on both the front and back sides.

To the left of the frame, the components of the left lens module are shown in exploded sequence. Closest to the frame 400 is the left micro-bezel 510, which has a shape matching the left socket with a continuous rim portion dimensioned to overlap the annular magnet 500 when installed. Outboard of the left bezel 510 is the left optical lens 520, which is depicted aligned with but spaced away from the bezel to show that the lens will be encapsulated by the bezel when assembled. A detail circle 14 encircles this left module region to indicate that an enlarged view is provided in FIG. 14.

In use, FIG. 13 depicts the steps a user would perform to assemble the eyewear in preferred embodiment 2. The user first seats the left lens 520 within the left bezel 510 to form a left lens module. The user then moves that module toward the left lens socket of frame 400 so that the outer surface of the micro-bezel 510 approaches the annular magnet 500. As the module nears the frame, magnetic attraction between the ferromagnetic bezel 510 and the annular magnet 500 pulls the module into seated engagement, automatically aligning the lens optical center with the frame's optical axis. The same procedure is followed for the right lens assembly 610/620 and the right annular magnet 600.

### FIG. 14—Left Lens Module Detail and Use

FIG. 14 isolates the left lens module region encircled by detail circle 14 in FIG. 13 and removes most of the frame to focus on the relationship between the left lens 520 and the left bezel 510. In this view, the left lens 520 appears as a slightly curved, generally oval plate. Immediately behind the lens is the left micro-bezel 510, which follows the same outline but is offset slightly rearward and radially outward, forming a thin ring that will wrap around the lens edge.

The exploded spacing in FIG. 14 emphasizes that the bezel 510 substantially surrounds the entire outer edge of the lens 520 when assembled, with the bezel's inner channel receiving the lens edge and its front and rear lips extending slightly beyond the lens surfaces. One could describe the bezel as a flexible ring-shaped guard that clips over the edge of a delicate glass disc, covering its circumference while leaving both faces exposed.

In use, the configuration shown in FIG. 14 corresponds to the subassembly step in which the left lens 520 is pressed into the left bezel 510. Depending on the joining method, the lens edge may snap into a groove in the bezel, be adhered with an optical adhesive, or be welded or press-fit. Once assembled, the left lens module behaves as a single unit that can be handled, cleaned, and inserted into or removed from the frame 400 without the lens edge ever contacting the frame material or external objects.

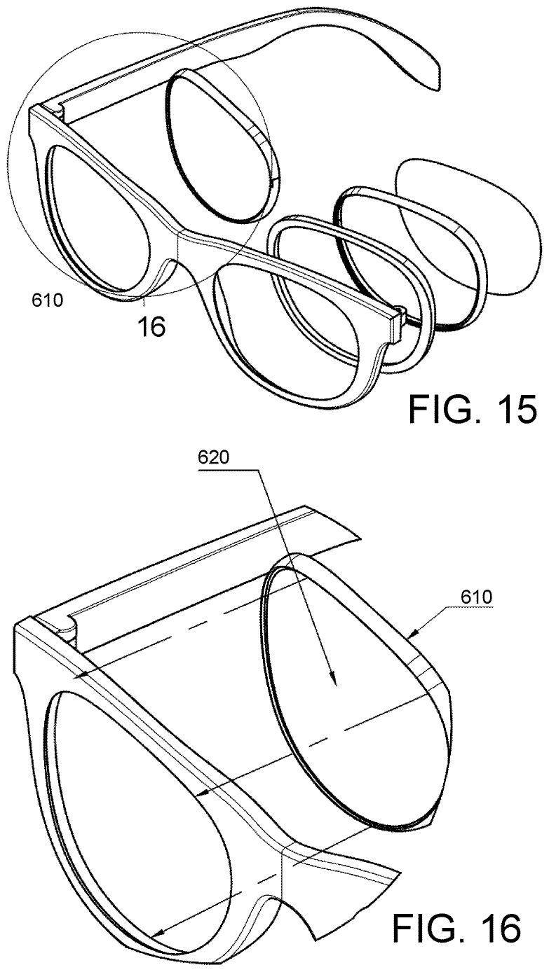

### FIG. 15—Left-Front Exploded View and Use

FIG. 15 presents a complementary perspective to FIG. 13, viewed from the left front side of the eyeglass assembly. The main frame 400 again occupies the center of the image, with its two lens sockets visible and the right temple extending rearward. The annular magnets 500 and 600 are shown nested within the continuous inner channels of the left and right sockets respectively, following the entire circumference of each opening.

In front of the frame 400, the right lens module (bezel 610 plus lens 620) is depicted in exploded relation similar to the left module arrangement in FIG. 13. The left lens 520 is likewise shown separated from the left bezel 510, illustrating the three-tier relationship of frame 400, bezel 510, and lens 520. A detail circle 16 encircles the region of the right lens socket and right annular magnet 600 to indicate that this interaction is enlarged in FIG. 16.

Functionally, FIG. 15 highlights how the annular magnets 500, 600 present continuous magnetic engagement surfaces around each socket. During use, when the user moves a lens module toward the frame, the ferromagnetic micro-bezel (510 or 610) experiences attraction along its entire inner rim. This produces a smooth, uniform “snap-in” feel as the module nests into the socket, and ensures that the retention force is distributed evenly rather than concentrated at a few discrete points.

### FIG. 16—Annular Magnet and Receptacle Detail; Right Lens Module Use

FIG. 16 zooms in on the right lens socket of frame 400 and the associated right lens module. In this view, only the right side of the frame 400 is shown, cropped near the bridge so that the right lens opening and surrounding structure dominate the image. Along the inner edge of this opening, the annular magnet 600 is shown as a thin, continuous band seated within a channel that runs completely around the socket rim. The channel confines the magnet radially and axially so that its inner surface is exposed to the lens module while its outer and rear surfaces are captured by the frame material.

In front of the frame portion, FIG. 16 shows the right micro-bezel 610 and right lens 620. The bezel 610 encircles the lens 620 and projects slightly beyond the lens surfaces, forming the protective lip described previously. The exploded spacing illustrates that when the module is pressed into the socket, the outer surface of the bezel 610 comes into close proximity with the inner face of the annular magnet 600 along the entire perimeter.

In practice, FIG. 16 corresponds to the fine-detail mechanics of installing or removing the right lens module in preferred embodiment 2. As the user presses the module 610/620 into the socket, the continuous magnet 600 attracts the ferromagnetic bezel 610 along the full circumference, pulling the module into intimate contact with the socket wall and maintaining parallelism between the lens and the frame. To remove the module, the user applies outward force at one or more points on the bezel rim, progressively overcoming the magnetic attraction around the circumference until the module is free.

### FIG. 17—Top Isometric Exploded View and Use

FIG. 17 provides a top-side, isometric, three-tiered exploded view of the preferred embodiment 2. The eyeglass frame 400 is shown from above, with both temples extending rearward and the bridge centered. Above the frame in the vertical direction are the left and right lens modules, each shown as a stacked pair of micro-bezel (510, 610) and lens (520, 620) aligned with, but spaced above, the corresponding frame sockets. The exploded tiers clearly show that each lens module is positioned directly over its respective socket, illustrating the vertical alignment of optical centers and the coaxial relationship of the module and socket geometries.

FIG. 17 can be likened to looking down onto a pair of eyeglasses laid on a table, with each lens and its surrounding bezel lifted straight up along a vertical line so that two floating discs hover directly above the frame openings. The magnets 500, 600 remain seated within the frame 400, hidden just inside the socket rims.

In use, FIG. 17 represents the motion path by which lens modules are installed or removed: the user aligns each module vertically with the corresponding socket and then moves it downward (for installation) or upward (for removal) along a path that is essentially perpendicular to the plane of the frame. The continuous magnetic engagement ensures that once seated, the modules resist unintended rocking or tilting within the sockets.

### FIG. 18—Front View of Frame 400 and Use

FIG. 18 is a front-side elevational view of the main frame 400 alone, with no lens modules installed. The two lens apertures appear as left and right ovals separated by a central bridge, much like a conventional eyeglass frame. Within each aperture, a thin inner rim is discernible; this rim defines the boundary of the socket and houses the continuous channel that receives the annular magnets 500 and 600. Although the magnets themselves may not be visually distinguished in the front view, the positions of the magnetic receptacles are indicated by subtle contour lines along the inner edges of the openings.

In terms of use, FIG. 18 illustrates the state of the frame when manufactured or shipped without lens modules installed. The user or optical professional can insert any compatible pair of micro-bezel lens modules into the sockets of frame 400, allowing the same frame design to be used with different prescriptions, tints, or lens materials over time. The frame 400 in preferred embodiment 2 thus functions as a reusable chassis that securely retains the lens cartridges via the internal annular magnets.

### FIG. 19—Left-Side Exploded View and Use

FIG. 19 provides a left-side, isometric, three-tiered exploded view of the preferred embodiment 2. The frame 400 is shown in profile from the left, with the left temple extending rearward and the left lens opening visible as a vertical ellipse. In front of this opening, the left lens module components are shown in a staggered arrangement: the left lens 520 furthest from the frame, the left micro-bezel 510 between the lens and the frame, and the frame 400 with its annular magnet 500 closest to the viewer. The separation between these elements emphasizes their stacked relationship along the line of sight.

This side perspective helps convey thickness relationships that are less apparent in the front views. The micro-bezel 510 is shown to have a finite axial thickness that spans the depth of the lens edge, with its protective lips extending slightly beyond the front and rear surfaces of the lens 520. The frame 400 is shown with a socket depth that accommodates the combined thickness of the bezel and lens while leaving the outer frame surface smooth and continuous.

In use, FIG. 19 corresponds to the user's experience when viewing the eyeglasses from the side during installation or removal of the left lens module. The user can grasp the bezel 510 at its outer edge and apply outward pressure along a line roughly perpendicular to the plane of the frame. The side view illustrates how the micro-bezel serves as a gripping surface and protective bumper, enabling confident manipulation of the lens module without contacting or stressing the bare lens edge.

### Relationship Between Preferred Embodiment 1 and Preferred Embodiment 2

As noted in the brief description, preferred embodiment 1 (FIGS. 1-8) and preferred embodiment 2 (FIGS. 13-19) share the same fundamental micro-bezel lens module architecture and cross-frame optical alignment scheme. Preferred embodiment 1 employs a plurality of discrete magnets 220-250, 320-350 positioned at selected locations around each lens socket of frame 100, while preferred embodiment 2 employs the annular magnets 500, 600 seated within continuous inner rim channels of frame 400. In both cases, the micro-bezel cartridges 200, 300, 510, 610 protect the lens edges, couple magnetically to the frame sockets, and permit rapid, tool-free interchange of the lens modules among compatible frames.

### Advantages Over Prior Art

The present subject matter provides numerous advantages over prior art interchangeable lens systems, particularly the wire-based magnetic attachment system disclosed in U.S. Pat. No. 8,641,188 to DiChiara. The most significant advantages relate to lens edge protection, stress distribution, and cross-frame optical alignment.
Lens Edge Protection: The micro-bezel cartridge provides comprehensive edge protection absent from the DiChiara wire system. While a wire surrounding the lens edge may provide a magnetic attachment interface, it offers minimal protection against edge impacts, compression forces during insertion/removal, or abrasive contact with external surfaces. The wire, being typically 0.2-0.5 mm in diameter, presents a small cross-sectional area that concentrates rather than distributes contact forces. In contrast, the micro-bezel of the present subject matter substantially encapsulates the lens edge with a material selected for energy absorption and stress distribution, functioning as a protective cartridge rather than merely an attachment interface.
Stress Distribution: During lens insertion, removal, or impact events, the micro-bezel distributes mechanical stresses circumferentially around the lens edge rather than concentrating stress at discrete contact points. This distribution is achieved through the bezel's annular geometry and resilient material properties, which allow the bezel to deform elastically under loading, absorbing energy that would otherwise be transmitted to the fragile lens edge. The DiChiara wire system, conversely, provides minimal stress distribution. Forces applied to the wire during lens handling are transmitted relatively directly to the lens edge at the wire-lens contact points, creating stress concentrations that can initiate edge chipping or cracking.
Cross-Frame Optical Alignment: The present subject matter enables a single lens module to be transferred among multiple frame styles while maintaining precise pupillary alignment and optical axis positioning. This capability is achieved through the standardization of lens module geometry and frame aperture positioning within defined frame families, combined with registration features that ensure repeatable rotational and translational positioning. The DiChiara patent makes no mention of cross-frame compatibility or optical alignment standards. The DiChiara lenses appear to be frame-specific, manufactured and fitted to particular frames without provisions for transfer to other frame styles with maintained optical performance.
Modular System Architecture: The present subject matter provides a comprehensive modular system wherein lens modules are manufactured as standardized components compatible with any frame within the same family. This modularity enables consumers to invest in a single set of prescription lens modules and multiple frames, reducing overall eyewear costs and providing flexibility to match frames to activities and occasions. The DiChiara system, while offering convenient magnetic lens attachment, does not appear to contemplate a standardized modular architecture enabling true cross-frame lens interchange.
Impact Resistance: The micro-bezel cartridge enhances the impact resistance of the lens assembly by providing a sacrificial protective structure that absorbs impact energy. Drop testing has demonstrated that lens modules incorporating the micro-bezel exhibit substantially reduced edge chipping and cracking compared to unprotected lenses subjected to equivalent impacts. The thin wire disclosed in DiChiara provides minimal impact protection due to its small cross-sectional area and lack of energy-absorbing capacity.

The cumulative effect of these advantages is an interchangeable lens system that combines user convenience (tool-free, rapid lens interchange), optical precision (maintained pupillary alignment across frame styles), economic value (one set of lenses serves multiple frames), and lens durability (comprehensive edge protection and stress distribution), thereby addressing critical unmet needs in the eyewear market.

### CONCLUSION

While the subject matter has been described with reference to a preferred embodiment and several alternative embodiments, those skilled in the art will recognize that various modifications and variations may be made without departing from the spirit and scope of the subject matter. For instance, the number and positioning of magnetic retention elements may be varied from the illustrated four-point pattern to three-point, five-point, or higher-order patterns depending on retention force requirements. The micro-bezel may incorporate decorative elements such as colored finishes, textured surfaces, or embedded graphics to enhance aesthetic appeal. The frame may incorporate adjustable-position magnetic elements to accommodate slight variations in lens module dimensions. The lens modules may incorporate identification features such as RFID tags or QR codes to enable automatic recognition by smartphone applications that track lens usage, maintenance schedules, or prescription information.

The foregoing detailed description and accompanying drawings have been provided by way of explanation and illustration, and are not intended to limit the scope of the appended claims. Many variations in the presently preferred embodiments illustrated herein will be apparent to one of ordinary skill in the art, and remain within the scope of the appended claims and their equivalents.

All original claims are hereby incorporated by reference.

1. An eyeglass assembly comprising:
a frame defining a first lens aperture and a second lens aperture, each lens aperture formed as an annular socket having an interior socket wall;
a first lens module removably receivable within the first lens aperture; and
a second lens module removably receivable within the second lens aperture;
wherein the first lens module comprises a first optical lens having a front surface, a rear surface, and a peripheral edge extending therebetween, and a first micro-bezel substantially encapsulating the peripheral edge of the first optical lens;
wherein the second lens module comprises a second optical lens having a front surface, a rear surface, and a peripheral edge extending therebetween, and a second micro-bezel substantially encapsulating the peripheral edge of the second optical lens;
wherein the frame further comprises magnetic retention elements associated with each of the first and second lens apertures, the magnetic retention elements being disposed on or within the respective interior socket walls; and
wherein each of the first and second micro-bezels comprises a resilient material that is either magnetic or ferromagnetic, or that incorporates one or more magnetic coupling elements, such that, when a lens module is received within the corresponding annular socket, the micro-bezel magnetically engages the magnetic retention elements to removably secure the lens module to the frame.

2. The eyeglass assembly of claim 1, wherein the magnetic retention elements of each annular socket comprise a plurality of discrete permanent magnets distributed at predetermined positions around a perimeter of the annular socket.

3. The eyeglass assembly of claim 2, wherein the plurality of discrete permanent magnets in each annular socket comprises four magnets positioned at approximately 2 o'clock, 4 o'clock, 8 o'clock, and 10 o'clock positions around the annular socket perimeter, and wherein each micro-bezel comprises four corresponding magnetic coupling elements positioned to align with the four magnets.

4. The eyeglass assembly of claim 1, wherein the magnetic retention elements of each annular socket comprise a single continuous annular magnet conforming to an inner perimeter of the respective annular socket and seated within a continuous channel formed in the interior socket wall.

5. The eyeglass assembly of claim 4, wherein at least a circumferential rim portion of each micro-bezel is formed from a ferromagnetic metal such that substantially an entire circumference of the rim portion magnetically couples to the annular magnet when the lens module is seated in the annular socket.

6. The eyeglass assembly of claim 1, wherein the first and second micro-bezels each comprise a thin annular structure that extends radially outward beyond the respective lens peripheral edge by about 0.5 mm to 2.0 mm and axially beyond the front and rear lens surfaces by about 0.2 mm to 1.0 mm to form a protective lip around the lens edge.

7. The eyeglass assembly of claim 1, wherein the frame is one of a plurality of frames belonging to a common frame family, all frames in the frame family defining lens apertures having standardized geometries and optical center positions such that the first and second lens modules are interchangeably receivable in any frame of the frame family while maintaining a predetermined interpupillary distance between optical centers of the first and second lenses.

8. A method of assembling an eyeglass system, comprising:
providing a frame defining first and second lens apertures, each lens aperture formed as an annular socket having an interior socket wall and magnetic retention elements disposed on or within the interior socket wall;
providing first and second lens modules, each lens module comprising an optical lens and a micro-bezel substantially encapsulating a peripheral edge of the optical lens, the micro-bezel comprising a material that is magnetic or ferromagnetic, or that incorporates one or more magnetic coupling elements;
aligning the first lens module with the first lens aperture such that the micro-bezel of the first lens module faces the magnetic retention elements of the first annular socket;
moving the first lens module toward the first annular socket until magnetic attraction between the micro-bezel and the magnetic retention elements pulls the first lens module into seated engagement within the first annular socket; and
repeating the aligning and moving steps for the second lens module and the second lens aperture, thereby magnetically securing both lens modules to the frame without tools.

9. The method of claim 8, wherein the magnetic retention elements comprise a plurality of discrete permanent magnets distributed around each annular socket perimeter and the aligning step includes orienting each lens module such that magnetic coupling elements on the respective micro-bezel are positioned to correspond with the discrete permanent magnets.

10. The method of claim 9, wherein each annular socket includes four discrete permanent magnets positioned at approximately 2 o'clock, 4 o'clock, 8 o'clock, and 10 o'clock positions and each micro-bezel includes four corresponding magnetic coupling elements, and wherein the moving step causes all four coupling elements to simultaneously magnetically engage the four permanent magnets to prevent rotation and lateral displacement of the lens module.

11. The method of claim 8, wherein the magnetic retention elements comprise a single continuous annular magnet seated within a continuous channel in each interior socket wall, and wherein the aligning and moving steps cause a ferromagnetic circumferential rim of each micro-bezel to magnetically couple along substantially an entire circumference of the annular magnet.

12. The method of claim 8, further comprising, before the aligning step, assembling each lens module by inserting the peripheral edge of the respective optical lens into an inner channel of the corresponding micro-bezel such that the micro-bezel forms a protective lip extending beyond front and rear surfaces of the lens.

13. The method of claim 8, further comprising removing one of the lens modules from the frame by applying an outward force to opposed edge regions of the micro-bezel sufficient to overcome magnetic attraction between the micro-bezel and the magnetic retention elements and to progressively separate the lens module from the corresponding annular socket.

14. The method of claim 8, wherein the frame belongs to a frame family comprising a plurality of frames sharing standardized lens aperture geometries and optical center positions, and wherein assembling the eyeglass system further comprises repeating the aligning and moving steps to transfer the first and second lens modules into another frame of the frame family while maintaining a predetermined interpupillary distance between optical centers of the lenses.

15. A method of using an interchangeable eyeglass system, comprising:
providing a pair of lens modules, each lens module comprising an optical lens having a prescribed optical center and a micro-bezel substantially encapsulating a peripheral edge of the optical lens;
providing a first eyeglass frame having left and right annular sockets with magnetic retention elements disposed on or within interior socket walls of the sockets;
magnetically installing the lens modules into the left and right annular sockets of the first eyeglass frame such that the micro-bezels magnetically engage the magnetic retention elements and the prescribed optical centers of the lenses are positioned at a predetermined interpupillary distance;
wearing the first eyeglass frame with the installed lens modules during a first user activity;
removing the lens modules from the first eyeglass frame by applying outward force to the micro-bezels sufficient to overcome magnetic attraction;
providing a second eyeglass frame belonging to a same frame family as the first eyeglass frame, the second eyeglass frame having left and right annular sockets dimensioned and positioned to receive the lens modules with the same predetermined interpupillary distance; and
magnetically installing the lens modules into the second eyeglass frame by engaging the micro-bezels with magnetic retention elements of the second eyeglass frame and wearing the second eyeglass frame during a second user activity.

16. The method of claim 15, wherein the magnetic retention elements of each frame comprise a plurality of discrete permanent magnets distributed around each annular socket perimeter and the micro-bezels each include a corresponding plurality of magnetic coupling elements, such that full magnetic engagement occurs only when each lens module is rotationally oriented to align all magnetic coupling elements with the permanent magnets.

17. The method of claim 15, wherein the magnetic retention elements of each frame comprise a single continuous annular magnet seated within each annular socket and each micro-bezel comprises a ferromagnetic circumferential rim, and wherein magnetically installing a lens module includes bringing the ferromagnetic rim into proximity with the annular magnet so that attraction is distributed substantially uniformly along the circumference.

18. The method of claim 15, further comprising, during the wearing steps, protecting edge regions of the lenses from impact and abrasion by interposing the micro-bezels between the peripheral edges of the lenses and surrounding environmental objects so that forces applied to outer edges of the lens modules are absorbed and distributed by the micro-bezels rather than being transmitted directly to the lenses.

19. The method of claim 15, wherein the first eyeglass frame comprises a professional or fashion frame style and the second eyeglass frame comprises an athletic or sports frame style, and wherein magnetically installing the same lens modules in the different frame styles maintains the prescribed optical centers at substantially identical positions relative to a wearer's pupils.

20. The method of claim 15, further comprising repeatedly transferring the lens modules among three or more frames belonging to the same frame family over time while retaining the same pair of optical lenses, thereby reducing cost of ownership by allowing a single set of prescription lenses to serve multiple functional and aesthetic roles.

21. The eyeglass assembly of claim 1, wherein each microbezel substantially encapsulates the peripheral edge of the corresponding optical lens by covering the peripheral edge and at least a portion of each corner region between the peripheral edge and the front surface of the lens and between the peripheral edge and the rear surface of the lens, such that the peripheral edge is circumferentially surrounded by the microbezel along substantially an entire perimeter of the lens.

22. The method of claim 8, wherein providing the first and second lens modules comprises providing each optical lens within a microbezel that forms a protective lip extending in the direction of an optical axis beyond distal portions of both the front and rear surfaces of the corresponding optical lens.
